(19) United States
(12) Patent Application Publication
(10) Pub. No.: US 2014/0058882 A1
(43) Pub. Date: Feb. 27, 2014

(54) Method and Apparatus for Ordering Recommendations According to a Mean/Variance Tradeoff

(71) Applicant: Opera Solutions, LLC, Jersey City, NJ (US)

(72) Inventors: William J.J. Roberts, Rockville, MD (US); Abhikesh Nag, San Diego, CA (US)

(73) Assignee: Opera Solutions, LLC, Jersey City, NJ (US)

(21) Appl. No.: 14/011,467

(22) Filed: Aug. 27, 2013

Related U.S. Application Data
(60) Provisional application No. 61/693,568, filed on Aug. 27, 2012.

(51) Int. Cl. G06Q 30/06

(52) U.S. Cl. CPC G06Q 30/0631
USPC 705/26.7

(57) ABSTRACT

Aspects of the present disclosure are directed to systems and methods that facilitate the recommendation of an item to a user. One particular aspect includes a method including the steps of: a) receiving a user request for a new recommendation including rating information for previously-selected items, b) retrieving a mean vector and a covariance matrix representing estimates of prior ratings for a plurality of items by other users, c) calculating a selection likelihood statistics as a function of the estimated mean vector, the estimated covariance matrix and the rating information provided by the, d) calculating ranking statistics as a function of the selection likelihood statistics, and e) transmitting a response to the user recommending at least one of the items not previously selected as a function of the ranking statistics. The recommended item may, for example, be a movie.

### CROSS REFERENCE TO RELATED APPLICATIONS

This application claims priority to U.S. Provisional Patent Application Ser. No. 61/693,568, entitled “Method and Apparatus for Ordering Recommendations According to a Mean/Variance Tradeoff,” filed on Aug. 27, 2012, which is incorporated by reference herein in its entirety.

U.S. patent application Ser. No. 12/705,932, entitled “METHOD AND APPARATUS FOR A RECOMMENDER SYSTEM USING ESTIMATED MEAN AND COVARIANCE,” filed on Feb. 15, 2010, is incorporated by reference in its entirety herein.

### TECHNICAL FIELD

This disclosure relates generally to recommending items to users, and in particular, to recommending items to users based on ratings associated with the items and/or ratings associated with other items.

### BACKGROUND

Recommender systems have been used to predict the likelihood that users will select an item from a set of items. For example, a recommender system may be used to predict the likelihood that a user will select and view a previously unselected movie from a collection of movies offered by an online movie streaming service. In this example, the collection of movies can include Titanic, Star Wars, The Godfather, Independence Day, and Jaws. A first user may have selected and/or viewed three movies (e.g., items): Titanic, Star Wars and The Godfather, but may not have selected and/or viewed Independence Day and Jaws. A second user may have selected and/or viewed Titanic and Jaws, but may not have selected and/or viewed Star Wars, The Godfather or Independence Day. A goal of the recommender system in this example may be to accurately predict the likelihood that the first user will select and view one or more of the movies that were not previously selected by the first user (e.g., Independence Day and/or Jaws), and to accurately predict the likelihood that the second user will select and view one or more of the movies that has not previously been selected by the second user (e.g., Star Wars, The Godfather and Independence Day). Based on this likelihood, the recommendation system can provide a recommendation to the user to recommend one or more of the previously unselected movies to the first and second users.

To provide accurate predictions, recommender systems often require large data sets of user data to effectively predict and/or recommend user selections. Processing these large data sets to arrive at individual user recommendations presents significant computational challenges. Generally, as depicted for example in FIG. 1, a set of item selections can be represented as a data-matrix 101 including columns representing individual users and rows representing individual items. In FIG. 1, k denotes the number of items and n denotes the number of users. For the example described above and illustrated by matrix 201 in FIG. 2, the number of items k equals 5 (k=5) and the number of users n eqauls 2 (n=2). Items that have been selected by users and items that have not been selected by users can be represented in the matrices 101, 201 in a variety of ways. For example, using a binary representation, if a j th product has been selected by the i th user, a value of “1” may be placed in the matix cell at position ij. If not, then a value of “0” may placed at position ij. Alternatively, the value placed in each matrix cell maty represent a ranking made by the i th user for the j th product (denoted yᵢ(j)).

One conventional approach to reducing computational complexity has utilized matrix factorization, which is schematically illustrated in FIG. 3. Typically, in matrix factorization, the data matrix is approximated by a product of matrices. For example, using matrix factorization for the data matrix 101, an integer l is first chosen(e.g., using one of a variety of heuristic approaches), and then the complete data-matrix 101 of size k×n is approximated by the product of a left matrix 301 of size k×l and a right matrix 302 of size l×n, each of which is typically substantially smaller than the size of the data matrix 101 (e.g., k×n). The left matrix 301 and right matrix 302 can generally be estimated by minimizing an error measure between the product of the left matrix 301 and right matrix 302 and the complete data matrix 101. Once estimated, missing ratings of a particular user can be predicted by determining the inner product of associated columns and rows from the left matrix 301 and the right matrix 302. For example, the value at matix cell ij can be predicted by calculating a dot product between the i th row of the left matrix 301 and the j th column of the right matrix 302.

Matrix factorization however presents a number of disadvantages. First, the heuristics available for selecting the integer l have proven to be limited, so that a variety of different values of l need to be tried to find one that minimizes error. In many cases a large l performs best. However, a large integer l causes the left matrix 301 and the right matrix 302 to be large, and manipulating these matrices becomes computationally expensive. For example, each time a new user or new item is added, the left matrix 301 and the right matrix 302 must be re-calculated.

A number of heuristic methods have been proposed to increase performance. However, the majority of these heuristic methods are generally too cumbersome for practical application, or limited to only work on particular data-sets.

Therefore, a need exists for a recommender method and system that achieves high performance without the disadvantages of the conventional matrix factorization approaches.

### SUMMARY

Exemplary embodiments of the present disclosure are directed to systems, methods, and non-transitory computer-readable media that facilitate the recommendation of an item to a user that the user has not previously selected based on ranking information for the item provided by other users and/or ranking information for items previously selected by the user.

In exemplary embodiments, a computer-implemented method, a system and a non-transitory computer-readable medium are disclosed to facilitate recommending an item by executing code to determine statistical information in response to a recommendation request associated with a user, calculating a selection likelihood statistic, specific to the user, for a previously unselected item available for selection by the user, and programmatically outputting a recommendation for the previously unselected item based on the selection likelihood statistic. The statistical information includes a mean vector and a covariance matrix. The mean vector and the covariance matrix are estimated based on rating information associated with previously selected items. The selection likelihood statistic is calculated based on the estimated mean vector, the estimated covariance matrix, and rating information associated with the previously selected item.

In exemplary embodiments, a method, system, and non-transitory computer-readable medium are disclosed to facilitate recommending an item to a user that the user has not previously selected by (a) receiving at a computer a request transmitted by the user over a network, where the request includes rating information provided by the user for previously-selected items; (b) retrieving information at the computer comprising a mean vector and a covariance matrix from a memory of the computer, where the mean vector and the covariance matrix represent estimates of prior ratings for a plurality of items by other users; (c) calculating a plurality of selection likelihood statistics by the computer for items in the plurality of items not previously selected by the user, where the selection likelihood statistics are calculated as a function of the estimated mean vector, the estimated covariance matrix and the rating information provided by the one user for the one user's previously-selected items; (d) calculating ranking statistics by the computer for the one or more items not previously selected by the one user as a function of the selection likelihood statistics; and (e) transmitting a response by the computer over the network recommending at least one of the items not previously selected as a function of the ranking statistics.

Exemplary embodiments of the present disclosure can calculate a ranking statistic for the previously unselected item based on the selection likelihood statistic, which can include a conditional mean vector associated with the user and a conditional covariance matrix associated with the user. The ranking statistic can include one or more weights calculated as the product of the inverse of the conditional covariance matrix and the conditional mean vector. The value of the ranking statistic for the previously unselected item is highest or lowest among a set of values of the ranking statistic for other previously unselected items.

Exemplary embodiments of the present disclosure can outputting the recommendation comprises transmitting a response to the recommendation request that includes the recommendation for the previously unselected item, transmitting the recommendation to the user, and/or transmitting the recommendation to a provider of the previously unselected item.

In exemplary embodiments, the recommended items can be movies, television programs, printed publications, e-books, CDs, DVDs, grocery items, products/merchandise available for purchase/rent, and/or electronic dating service candidates.

In exemplary embodiments, the rating information corresponds to ratings received from the user for items previously selected by the user and/or to ratings received from one or more other users for items previously selected by the one or more other users including, e.g., items that have not been previously selected by the user.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWING

A more complete understanding of the present disclosure may be realized by reference to the accompanying drawing in which:

FIG. 1 is schematic diagram showing a user/item data-matrix as may be configured in a conventional recommender system;

FIG. 2 is a schematic drawing showing an example of a subset of the data-matrix of FIG. 1;

FIG. 3 is a schematic drawing depicting a conventional matrix factorization approach for estimating empty cells in the data-matix of FIG. 1;

FIG. 4 is a block diagram of an exemplary embodiment of a recommender system according to the present disclosure;

FIG. 5 is a flowchart depicting an operation of a method for ordering outputs of a recommender system according to an aspect of the present disclosure;

FIG. 6 is a flowchart further depicting a first aspect of the method of FIG. 5; and

FIG. 7 is an exemplary client server implementation of an exemplary embodiment of the recommender system according to an aspect of the present disclosure.

The illustrative embodiments are described more fully by the Figures and detailed description. The inventions may, however, be embodied in various forms and are not limited to specific embodiments described in the Figures and detailed description.

### DETAILED DESCRIPTION

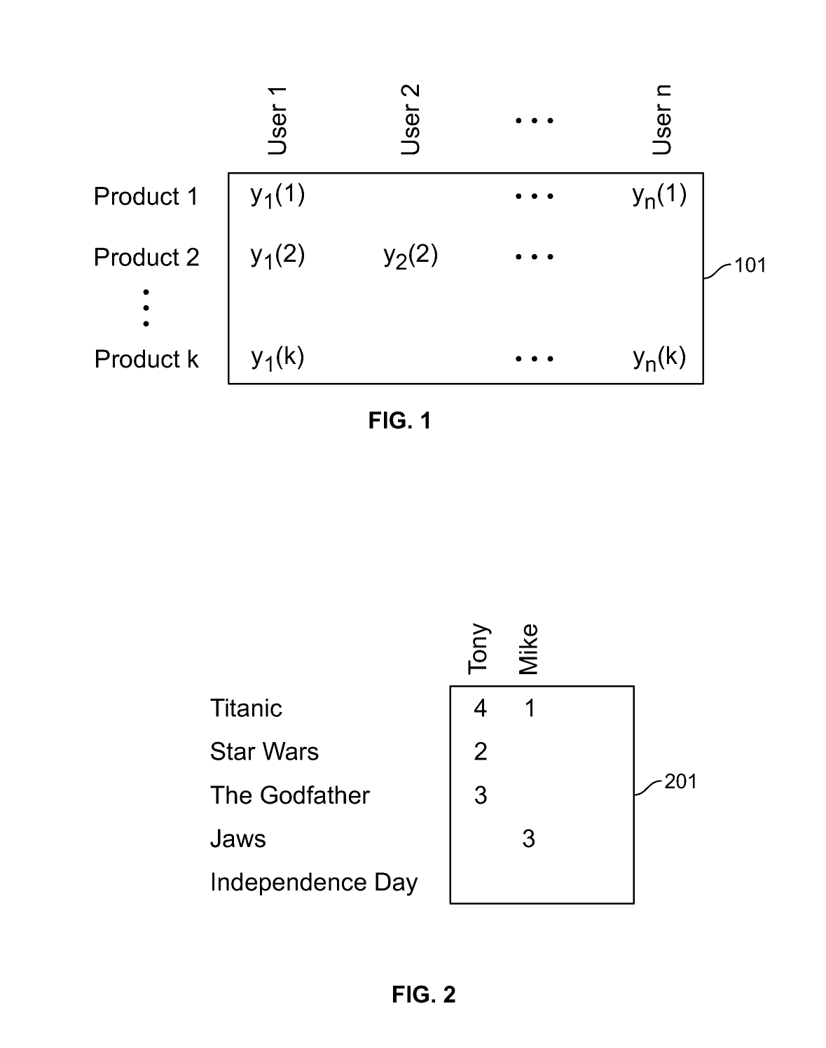

Exemplary embodiments of the present disclosure relate to a system and method for recommending items to users based on statistical information, ratings information, and user data, as discussed in detail below in connection with FIGS. 1-7.

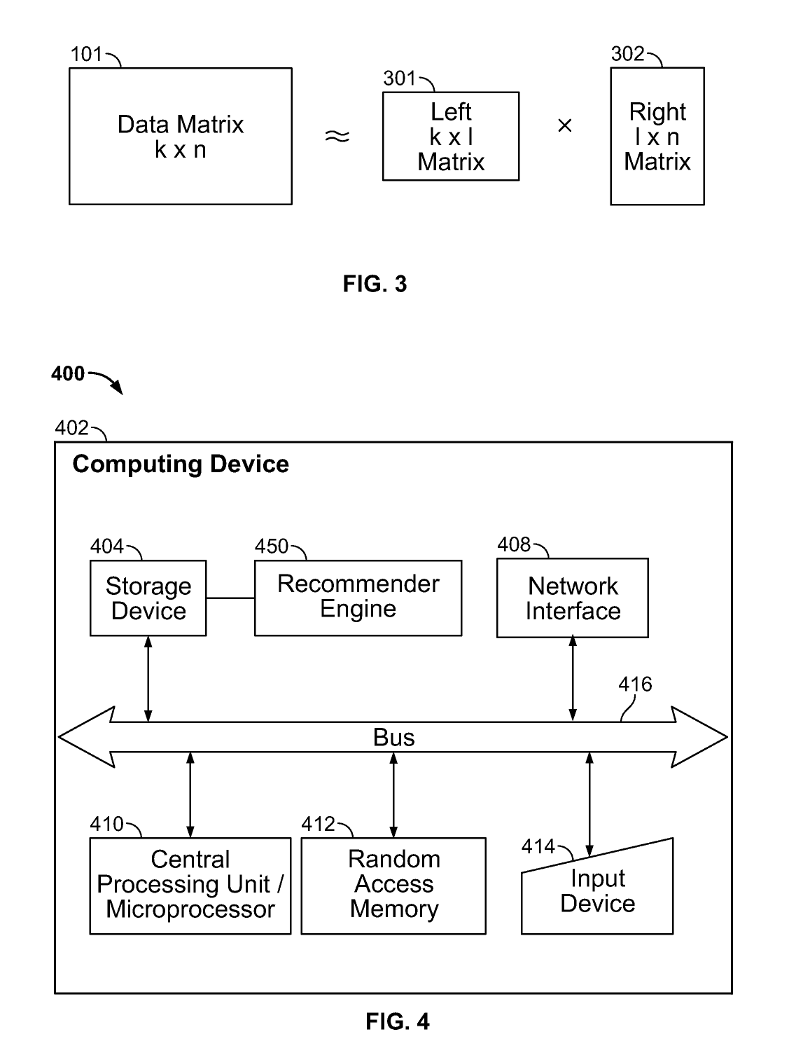

Exemplary embodiments of the present disclosure alleviate to a great extent disadvantages associated with the conventional recommender systems. For example, the matrix factorization approach described with reference to FIG. 3, utilized by conventional recommender systems, is poorly defined, such that it can be difficult to repeat results obtained by others. In contrast to the conventional matrix factorization approach, exemplary embodiments of the present disclosure provide a well defined and repeatable approach to identifying items that a user is likely to select. As such, exemplary embodiments disclosed herein can perform well “out-of-the-box” without requiring additional optimization.

In conventional recommender systems, the addition of new users and new products to the data set used for determining which items to recommend typically required extensive re-estimation. In exemplary embodiments, prediction of ratings for new users requires no re-estimation. To add new products, the dimension of the mean and covariance is simply increased. This is a simple procedure and is substantially easier than what is required in conventional recommender systems.

FIG. 4 is a diagram showing hardware and software components of an exemplary recommender system 400 capable of performing the processes described herein. The system 400 includes a computing device 402, which can include a storage device 404, a network interface 408, a communications bus 416, a central processing unit (CPU) 410, e.g., a microprocessor, and the like, and a random access memory (RAM) 412. In some embodiments, one or more input devices 414, e.g., a keyboard, a mouse, and the like, can be in communication with the computing device 402. In some embodiments, the computing device 402 can also interface with a display, e.g., a liquid crystal display (LCD), a cathode ray tube (CRT), and the like. The storage device 404 can include any suitable, computer-readable storage medium, e.g., a disk, non-volatile memory, read-only memory (ROM), erasable programmable ROM (EPROM), electrically-erasable programmable ROM (EEPROM), flash memory, field-programmable gate array (FPGA), and the like. The computing device 402 can be, e.g., a networked computer system, a personal computer, a smart phone, a tablet, and the like. In some embodiments, the computing device 402 can be implemented as a server in a client-server environment. An exemplary client-server environment is shown in FIG. 7.

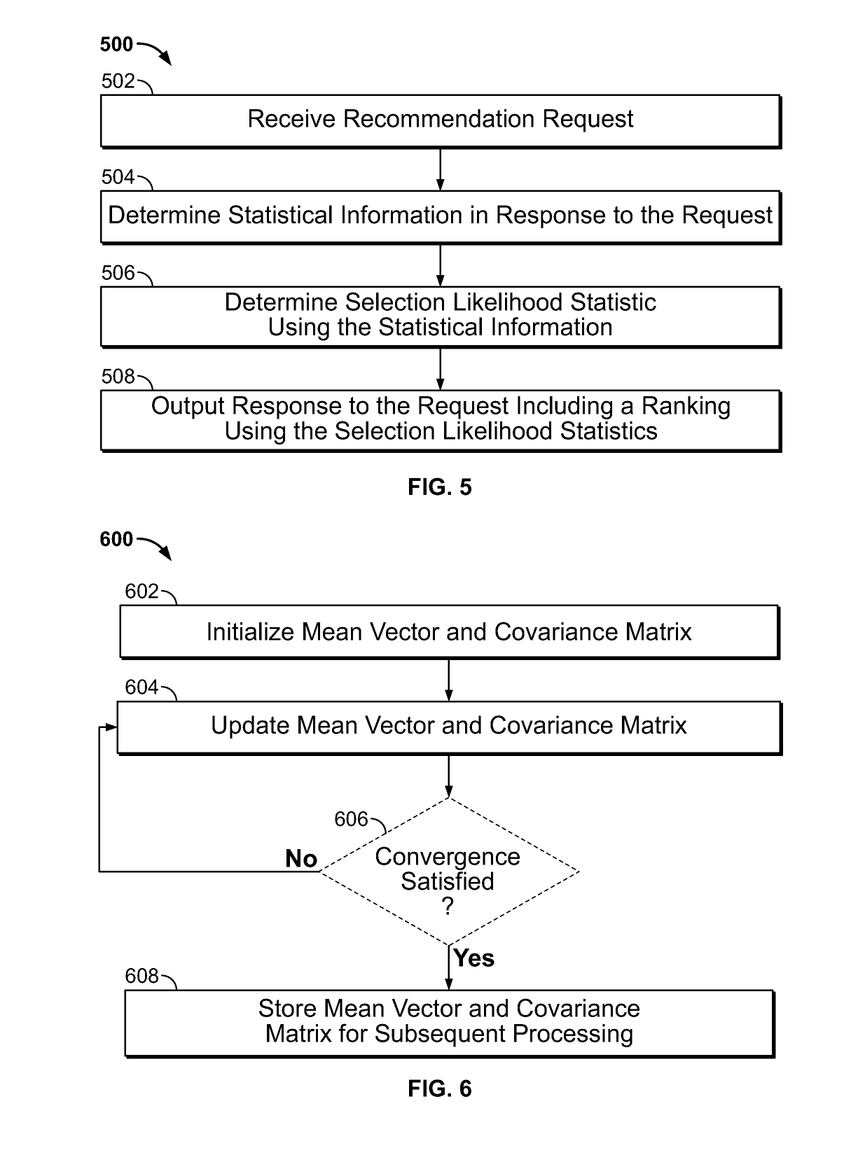

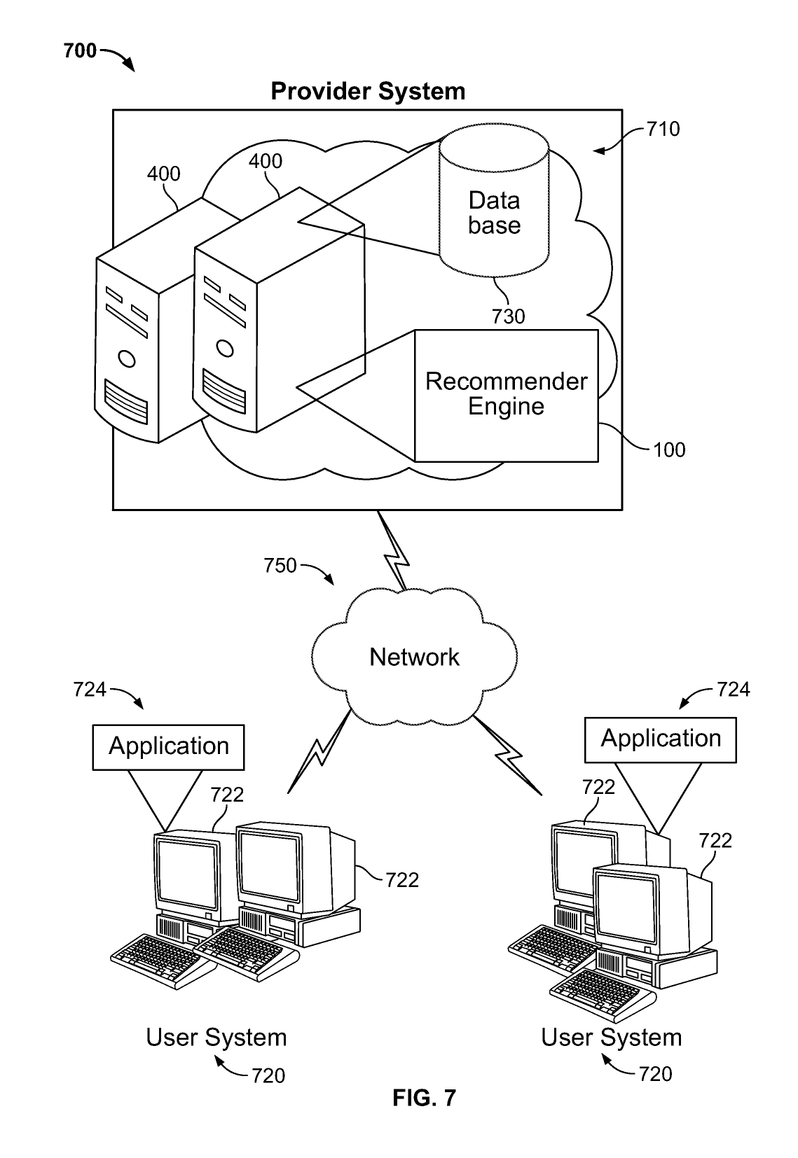

In exemplary embodiments, a recommender engine 450 can be embodied as computer-readable/executable program code stored on the one or more non-transitory computer-readable storage device 404 and can be executed by the CPU 410 using any suitable, high or low level computing language and/or platform, such as, e.g., Java, C, C++, C#, Matlab, .NET, and the like. Execution of the computer-readable code by the CPU 410 can cause the engine 450 to implement one or more processes for recommending items to users. For example, in exemplary embodiments, the recommender engine 450 can be programmed and/or configured to perform the exemplary processes shown in FIGS. 5 and 6. Some examples of items that can be recommended by the recommender system can include movies, television programs, printed publications, e-books, music files (e.g., MP3s, Way, FLAC files), CDs, DVDs, grocery items, electronic dating service candidates, products/merchandise available for purchase, and/or any other items suitable for recommendation to users.

The network interface 408 can include, e.g., an Ethernet network interface device, a wireless network interface device, any other suitable device which permits the computing device 402 to communicate via the network, and the like. The CPU 410 can include any suitable single- or multiple-core microprocessor of any suitable architecture that is capable of implementing and/or executing the engine 450, e.g., an Intel processor, and the like. In some embodiments, one or more Graphics Processing Units (GPUs) can be used to implement the engine 450, or portions thereof rather than, or in addition to, the CPU 410.

In some embodiments, the programming language/code used to implement the engine 450 can be augmented using Basic Linear Algebra Subprograms (BLAS), as described herein. For efficient memory usage, BLAS routines can operate on a designated memory location in RAM 406. The designated memory can be large enough, for example, to hold a k×k matrix. The designated k×k memory location can hold a kₜ×kₜ matrix when processing observations from at th user.

The random access memory 412 can include any suitable, high-speed, random access memory typical of most modern computers, such as, e.g., dynamic RAM (DRAM), and the like. The CPU 410 can retrieve and store data to and from the storage device 404 and/or the RAM 412. For example, a data-matrix, such as data matrix 101 depicted by FIG. 1, may be stored on the storage device 404 and/or a RAM 412. In some embodiments, the data/information and/or executable code for implementing the engine 450 can be retrieved from the storage device 404 and copied to RAM 412 during and/or upon implementation of the processes described herein. Once the data/information has be used, updated, modified, replace, and the like, the data/information may be copied from RAM 412 to the storage device 404.

FIG. 5 is a flowchart an overall process 500 that can be implemented by exemplary embodiments of the recommender engine 450 in accordance with aspects of the present disclosure. At step 502, the recommender engine 450 can receive a recommendation request. The recommendation request can request the recommender engine 450 to execute code to identify recommended items for users from a collection of items based on data maintained and/or received by the recommender engine 450. For example, in exemplary embodiments, the data utilized by the engine 450 can be represented as using the data matrix 101.

In some embodiments, the recommendation request can be received from a user. For example, the user can interact with the recommendation engine 450 using an electronic device programmed and/or configured to interact with the recommender system (e.g., via a communication network). The user may request a recommendation to identify and/or discover items that may be of interest to the user. In some embodiments, the recommendation request can be received from an entity providing the items to the user and/or the request can be automatically generated based on one or more parameters specified by the entity (e.g., a time parameter specifying an periodic interval at which to generate recommendations). The entity may request recommendations for the user to identify items for the user that may be of interest to the user.

At step 504, the recommender engine can be programmed and/or configured to determine statistical information by processing the data maintained and/or received by the recommender engine 450 and represented by the data matrix 101. In exemplary embodiments, the statistical information can be determined by the engine 450 by programmaticaly estimating a mean vector μ and a covariance matrix R using the data matrix 101. At step 506, the engine 450 can be programmed and/or configured to utilize the statistical information as well user data to determine selection likelihood statistics. For example, the estimated mean vector μ and covariance matrix R determined by the engine 450 can be used by the engine 450 along with the user data to calculate selection likelihood statistics. The user data can include information about which items the user has previously selected, which items the user has not yet selected, rating information specified by the user with respect to the items previously selected, and/or rating information specified by other users for items that the other users have previously selected.

The selection likelihood statistics determined by the engine 450 can include, for example, a conditional mean \hat{μ} and a conditional covariance \hat{R} (the symbol \hat{Q} is used interchangeably herein to denote the conditional covariance). The conditional mean \hat{μ} can be defined by the following mathematical expression, which can be evaluated by the engine 450.

\hat{μ}=R_{xz}R_{z}⁻¹(1−μ_{z})+μₓ (1)

where R_{xz}, R_{z}, μₓ, and μ_{z} are appropriate sub-matrices and sub-vectors from the covariance matrix R and the mean vector μ, respectively. These sub-matrices and sub-vectors can be specified by identifying a matrix Hₜ given by a k×k identity matrix I for which rows, corresponding to indices items that the user has yet to select, are deleted.

Using the matrix Hₜ, the sub-matrices and sub-vectors can be defined by the following mathematical expressions: R_{xz}=HₓRH_{z′}; R_{z}=H_{z}RH_{z′}; μₓ=Hₓμ; and μ_{z}=H_{z}μ.

The conditional covariance \hat{r} is given by the following mathematical expression:

\hat{R}=Rₓ_{ₜ}−Rₓ_{ₜ}_{y}_{ₜ}R_{y}_{ₜ}⁻¹Rₓ_{ₜ}_{y}_{ₜ}′ (2)

Thus, the mean vector μ, the covariance matrix R, and the indices of the items the user has already selected (e.g., given by the matrix H) are parameters utilized by the engine 450 to output a conditional mean \hat{μ} and a conditional covariance \hat{R} as selection likelihood statisitcs.

At step 508, the engine 450 programmatically output a final answer in reponse to the request (e.g., recommendations of one or more items that have not yet been selected by the user). For example, in exemplary embodiments, the final answer includes the items in a ranked order. In some embodiments, the conditional mean \hat{μ} and/or conditional covariance \hat{R} (or \hat{Q}) are used to rank the items. A ranking based on solely the conditional mean provides an intuitive approach. However, utilizing both the conditional mean \hat{μ} and/or conditional covariance \hat{R} can allow the engine 450 to take into account the variance of the conditional mean elements and to account for the correlation between the conditional mean elements. In exemplary embodiments, the variances and correlations may be taken into account using a mean-variance tradeoff to rank the items, which can be accomplished by finding a vector w that minimizes the following mathematical expression:

J(w)=w\hat{Q}w−λ*\hat{μ}′w(3)

The solution that minimizes Eq. 6 above can be given by w=Q⁻¹μ. Thus, the ranking order in which the items are placed can be determined by multiplication of the conditional mean \hat{μ} by the inverse of the conditional covariance \hat{Q} (or \hat{R}). In some embodiments, the items receiving the highest rank can be the recommended or most recommended item. In some embodiments, the items receiving the highest rank can be the recommended or most recommended item.

FIG. 6 is a flowchart illustrating an exemplary process 600 for the step of determining statistical information in FIG. 5 (i.e. step 504). To begin, at step 602, the engine 450 can initialize the mean vector μ and the covariance matrix R. The engine 450 can initially start without providing the mean vector and/or the covariance matrix and can estimate this statistical information using the data-matrix 101 described herein.

In one embodiment of the present disclosure, an initial mean vector μ can be provided by an arithmetic mean of observed ratings (e.g., ratings associated with items in the collection of items) and an initial value of the covariance matrix R can be provided by a matrix that has non-zero off-diagonal elements and diagonal elements equal to sample variances.

Exemplary mathematical formulae for the mean vector μ and the covariance matrix R are now presented. The number of selections made by the t th user can be denoted as kₜ where 0≦kₜ≦k. The matrix Hₜ can be a kₜ×k matrix given by identity matrix I with rows corresponding to indices of missing ratings from the t th user deleted. A k×k diagonal matrix N can be given by N=Σₜ₌₁ⁿHₜ′Hₜ, where “′” denotes a vector or matrix transpose (e.g., Hₜ′ denotes the transpose of the matrix Hₜ.

Elements along the diagonal of N thus equal a quantity of times each item was selected by a user. In some embodiments, the mean vector μ is initialized by μ=N⁻¹Σₜ₌₁ⁿHₜ′1. In some embodiments, the mean vector μ may be assumed to be a vector of zeros, i.e. μ=0.

In some embodiments, the covariance matrix R can be initialized based on an un-normalized sample covariance matrix S. The un-normalized sample covariance matrix S can be dedefined by the following mathematical expression S=Σₜ₌₁ⁿHₜ′(1−Hₜμ)′Hₜ. Using the un-normalized sample covariance matrix S, engine 450 can programmatically initalize the covariance matrix R by evaluating the following mathematical expression: R=N^{1/2}SN^{-1/2}.

At step 604, the engine 450 can be programmed and/or configured to update the mean vector μ and the covariance matrix R. For example, performance of the processes 500 and 600 may be improved by updating any existing mean vectors and covariance matrices using the Maximum Likelihood (ML) theory.

With missing ratings, a ML estimate is a closed form expression given by

$$μ = {( {\sum }_{t = 1}^{n} {H}_{{y}_{t}} {R}_{{y}_{t}}^{- 1} {H}_{{y}_{t}} )}^{- 1} {\sum }_{t = 1}^{n} {H}_{{y}_{t}} {R}_{{y}_{t}}^{- 1} {y}_{t} \qquad ( 4 )$$

where R_{y}_{ₜ}=H hd y_{ₜ}RH_{y}_{ₜ}.

No such closed-form ML estimate of the covariance matrix is known. Thus, existing values of the covariance matrix are updated using a modified gradient descent algorithm given by

$$R = R + γ R ( {\sum }_{t = 1}^{n} {H}_{{y}_{t}} ( {R}_{{y}_{t}}^{- 1} - {R}_{{y}_{t}}^{- 1} ( {y}_{t} - {μ}_{{y}_{t}} ) {( {y}_{t} - {μ}_{{y}_{t}} )}^{′} {R}_{{y}_{t}}^{- 1} ) {H}_{{y}_{t}} ) R \qquad ( 5 )$$

where μ_{y}_{ₜ}=H_{y}_{ₜ}μ and γ>0 is a predetermined constant.

In some embodiments, an existing mean vector and covariance matrix could have be obtained from initialization at step 602, or from an earlier execution of step 604 (i.e. the mean vector μ and the covariance matrix R may have previously been update and may be subsequently updated again). With respect to the latter (e.g., updating the previously updated mean vector μ and covariance matrix R), the engine 450 can be programmed and/or configured to continuously execute step 604 until convergence criteria are satisfied as described in more detail below. The engine 450 mean vector and covariance matrix may generally be processed in RAM 412.

In some embodiments, an existing mean vector and covariance matrix could have be obtained from initialization at step 602, or from an earlier execution step 604 (i.e. the mean vector μ and the covariance matrix R may have previously been update and may be subsequently updated again). With respect to the latter (e.g., updating the previously updated mean vector μ and covariance matrix R), the engine 450 can be programmed and/or configured to continuously execute step 604 until convergence criteria are satisfied as described in more detail below. For example, after the mean vector μ and covariance matrix R are updated at step 604, the engine 450 can check whether convergence has been achieved at step 606 (e.g., by determining whether the convergence criteria has been satisfied). If not, the engine 450 can repeat step 604. Otherwise, the engine 450 can be programmed and/or configured to store the mean vector μ and covariance matrix R for further subsequent processing at step 608. For example, in exemplary embodiments, the mean vector μ and covariance matrix R can be stored on the storage device 404.

In exemplary embodiments, a likelihood or probability p that a user will select an item can be used to determine whether convergence has been achieved. The likelihood or probability p can be given by the following mathematical expression:

$$p ( {y}^{n} ; μ , R ) = {\prod }_{t = 1}^{n} \frac{exp - {( {y}_{t} - {μ}_{{y}_{t}} )}^{′} {R}_{{y}_{t}}^{- 1} ( {y}_{t} - {μ}_{{y}_{t}} ) / 2}{{( 2 π )}^{{k}_{t} / 2} {\vert {R}_{{y}_{t}} \vert}^{1 / 2}} \qquad ( 6 )$$

where yⁿ={y₁, . . . , yₙ} represents all observed item ratings in the data-matrix 101. In some embodiments, the convergence criteria can be satisfied once changes in the likelihood calculated using successive estimates of the mean vector μ and covariance matrix R are sufficiently small (e.g., smaller than a specified value). In this case, the engine 450 can set a Boolean flag to indicate that convergence has occurred and the engine can proceed to step 608. Otherwise, the Boolean flag is not set and step 604 is re-executed.

In some embodiments, a sequence of BLAS routines can be implemented to perform the updating described with respect to step 604. For observed ratings from the t th user, a matrix R_{y}_{ₜ}=H_{y}_{ₜ}RH_{y}_{ₜ} can be formed by copying relevant elements of the covariance matrix into the designated memory location. In this and other similar operations matrix multiplications are not required. A matrix R_{y}_{ₜ} can be overwritten by its upper triangular Cholesky decomposition U_{y}_{ₜ} where R_{y}_{_{t=U}}_{y}_{ₜ}U_{y}_{ₜ}. Cholesky decomposition can be performed using a BLAS routine called “spotrf.” A BLAS routine called “strsm” can be used to calculate U_{y}_{ₜ}⁻¹(yₜ−μ_{y}_{ₜ}), followed by a another call to “strsm” to calculate R_{y}_{ₜ}⁻¹(yₜ−μ_{y}_{ₜ}). In a similar fashion two calls to “strsm” can be used to calculate R_{y}_{ₜ}⁻¹yₜ. A matrix R_{y}_{ₜ}⁻¹(yₜ−μ_{y}_{ₜ})(y_{t-μ}_{y}_{ₜ})′R_{y}_{ₜ}⁻¹, can be calculated using a BLAS routine called “ssyrk”. A matrix R_{y}_{ₜ}⁻¹ can be calculated using a BLAS called “spotri”.

In some embodiments, the BLAS function calls can also be used to calculate the quantities in step 606. For example, a scalar (yₜ−μ_{y}_{ₜ})R_{y}_{ₜ}⁻¹(yₜμ_{y}_{ₜ}), required can be calculated by squaring and summing the elements of U_{y}_{ₜ}⁻¹(yₜ−μ_{y}_{ₜ}). A required determinant can be calculated using the identity log |R_{y}_{ₜ}|=2Σⱼ log((U_{y}_{ₜ})ⱼⱼ) where (U_{y}_{ₜ})ⱼⱼ is the jj th element of U_{y}_{ₜ}.

A numerical example of for determining selection likelihood statistics for items and ranking the items by the selection likelihood statistics in an answer/response output by the engine 450 is now described. In the present example, the quantity of products can equal five (k=5) with covariance matrix R and mean vector μ given by, respectively,

$$\begin{matrix}R = [ \begin{matrix}1.3 & .12 & .11 & .2 . & .3 \\ .12 & 1.4 & .13 & .21 & .12 \\ .11 & .13 & 1.2 & .15 & .17 \\ .2 & .21 & .15 & 1.3 & .16 \\ .3 & .21 & .17 & .16 & 1.5\end{matrix} ] \\ and & ( 7 ) \\ μ = [ \begin{matrix}3.3 \\ 2.2 \\ 3.1 \\ 1.4 \\ 3.5\end{matrix} ] . & ( 8 )\end{matrix}$$

A user t may have rated products 1, 2 and 4 where each rating is an integer from 1 to 5 stars. The t^{th} user has rated product 1 as 3 stars, product 2 as 2 stars, and product 4 as 3 stars. We represent these ratings as the vector yₜ given by

$${y}_{t} = [ \begin{matrix}3 \\ 2 \\ 3\end{matrix} ] . \qquad ( 9 )$$

The recommendation problem is to predict the ratings for products 3 and 5 and rank these taking into account the fact that they are correlated. The required ratings can be denoted as a vector xt.

The relevant sub-matrices and sub-vectors of R and μ are thus given by:

$$\begin{matrix}{R}_{yy} = [ \begin{matrix}1.30 & 0.12 & 0.20 \\ 0.12 & 1.40 & 0.21 \\ 0.20 & 0.21 & 1.30\end{matrix} ] & ( 10 ) \\ {R}_{xx} = [ \begin{matrix}1.20 & 0.17 \\ 0.17 & 1.7\end{matrix} ] & ( 11 ) \\ {R}_{xy} = [ \begin{matrix}0.11 & 0.30 \\ 0.13 & 0.12 \\ 0.15 & 0.16\end{matrix} ] & ( 12 ) \\ {μ}_{y} = [ \begin{matrix}3.30 \\ 2.20 \\ 1.40\end{matrix} ] & ( 13 ) \\ {μ}_{x} = [ \begin{matrix}3.10 \\ 3.50\end{matrix} ] & ( 14 )\end{matrix}$$

The conditional mean μ is given by

$$\begin{matrix}\hat{μ} = {R}_{xy} {R}_{yy}^{- 1} ( {y}_{t} - {μ}_{y} ) + {μ}_{x} \\ = [ \begin{matrix}3.22 \\ 3.56\end{matrix} ] ( 16 )\end{matrix} \qquad ( 15 )$$

The conditional covariance Q is given by

$$\begin{matrix}Q = {R}_{xx} - {R}_{xy} {R}_{yy}^{- 1} {R}_{xy}^{′} & ( 17 ) \\ = [ \begin{matrix}1.17 \\ 0.13\end{matrix} \begin{matrix}0.13 \\ 1.42\end{matrix} ] & ( 18 )\end{matrix}$$

The ranking weights w are calculated using

$$\begin{matrix}w = {Q}^{- 1} \hat{μ} \\ = [ \begin{matrix}2.50 \\ 2.29\end{matrix} ] ( 20 )\end{matrix} \qquad ( 19 )$$

Thus, product 3 is ranked first and product 5 is ranked second by the engine 450. Notably, the rank order in this example differs from the ranked order that would have been output if only the conditional mean \hat{μ} was used.

FIG. 7 is a block diagram of an exemplary client-server environment 700 configured to implement one or more embodiments of the recommender system 400. The environment 700 includes a provider system 710 operatively coupled to user systems 720, via a communication network 750, which can be any network over which information can be transmitted between devices communicatively coupled to the network. For example, the communication network 750 can be the Internet, an Intranet, virtual private network (VPN), wide area network (WAN), local area network (LAN), and the like. The provider system 710 can include the recommender system 400 executing the engine 450 and can be configured to retrieve and store data/information in databases 730.

The user systems 720 can include one or more electronic devices 722 configured to communicate with the provider system 710 via the network 750. In exemplary embodiments, the electronic devices 722 can include an application 724 programmed and/or configured to facilitate access or execute the engine 450 to search for and request recommendations for items provided by the provider system. In some embodiments, the application 724 implemented by one or more of the electronic devices 720 can be a web-browser capable of navigating to one or more web pages hosting graphical user interfaces (GUIs) generated by the environment 450 that allow the operators of the electronic devices to interact with the engine 450. In some embodiments, the application 724 implemented by one or more of the electronic devices 720 can be an application specific to the system 400 to permit access to the engine 450 of the system 400. In some embodiments, the application specific to the system 400 can be a mobile application installed and executed by the electronic devices 720.

In exemplary embodiments, the provider system 710 can allow users to search, identify, select, and/or rate items made available to the users by the provider system 710. For example, in one embodiment, the provider system can be a movie streaming service that provides access to a library (or collection) of movies, which may be stored in the database 730. Uses of the provider system 710 can access the library of movies using the electronic devices 720 and can select movies from the library to view. After a user has viewed a selected movie, the user can rate the movie (e.g., on a scale of 5). The provider system 710 can store information in the user's profile corresponding to the movie that was selected and the rating specified by the user in the database 730.

When the user accesses the library provided by the provider system 710, the provider system 710 can execute the recommender engine 450 to request recommendations of movies to suggest the user and/or the user can submit the recommendation request. In response to the request, the engine 450 can execute one more processes, such as the exemplary processes described herein to generate one or more recommended movies to the user that have not previously been selected by the user based the movies previously selected by the user having rating information and movies previously selected by other users that have rating information (including movie that have not yet been selected by the user). For example, the engine 450 can return a previously unselected movie having the greatest likelihood of being selected by the user and/or can return a ranked list of movies based on the likelihood that the user will select the movies.

While the items to be selected in the present embodiment are movies, those of ordinary skill in the art will recognize that the items to be selected are not limited to movies. The present disclosure contemplates that exemplary embodiments of the recommender system can be used to recommend items for user selection other than movies. For example, exemplary embodiments of the recommender system can be used to recommend other media (e.g., music, books, television shows, etc.), products/merchandise available for purchase, and/or any other suitable items. In addition to uses targeted to make recommendations to users, recommender systems can also be used also for example to predict user selection of items without explicit recommendation. For example, recommender system can be used in conjunction with Internet dating sites to predict how users will choose potential mates, in grocery stores to predict buying habits of shoppers, for movie streaming service to identify new movies to include in the library based a likelihood that a specified number of user would select the movie, and so on. In this case, the values provided in each of the matrix cells may represent a probability of selection, or as an analog to this, a favorability rating.

In addition, while the recommender system 400 and/or recommender engine 450 have been depicted as being included in the provider system 710, those of ordinary skill in the art will recognize that the recommender system 400 and/or the recommender engine 450 can be separate from the provider system 710 such that the provider system 710 can interface with the recommendation system 400 and/or recommendation engine 450 via the network 750.

What is claimed is:

1. A computer-implemented method for recommending an item, the method comprising:
executing code to determine statistical information in response to a recommendation request associated with a user, the statistical information including a mean vector and a covariance matrix, the mean vector and the covariance matrix being estimated based on rating information associated with previously selected items;
calculating a selection likelihood statistic, specific to the user, for a previously unselected item available for selection by the user, the selection likelihood statistic being calculated based on the estimated mean vector, the estimated covariance matrix, and rating information associated with the previously selected item; and
programmatically outputting a recommendation for the previously unselected item based on the selection likelihood statistic.

2. The method of claim 1, further comprising calculating a ranking statistic for the previously unselected item based on the selection likelihood statistic.

3. The method of claim 1, wherein outputting the recommendation comprises transmitting a response to the recommendation request, the response including a recommendation recommending the previously unselected item.

4. The method of claim 3, wherein outputting the recommendation comprises transmitting the recommendation to the user.

5. The method of claim 3, wherein outputting the recommendation comprises transmitting the recommendation to a provider of the previously unselected item.

6. The method of claim 1, wherein the selection likelihood statistic comprises a conditional mean vector associated with the user and a conditional covariance matrix associated with the user.

7. The method of claim 6, further comprising calculating a ranking statistic for the previously unselected item based on the selection likelihood statistic, and
wherein the ranking statistic comprises one or more weights calculated as the product of the inverse of the conditional covariance matrix and the conditional mean vector.

8. The method of claim 7, wherein the value of the ranking statistic for the previously unselected item is highest or lowest among a set of values of the ranking statistic for other previously unselected items.

9. The method of claim 1, wherein the items comprise one or more of movies or television programs.

10. The method of claim 1, wherein the items comprise one or more of printed publications, e-books, CDs, or DVDs.

11. The method of claim 1, wherein the items comprise grocery items.

12. The method of claim 1, wherein the items comprise electronic dating service candidates.

13. The method of claim 1, wherein the rating information corresponds to ratings received from the user for the previously selected items by the user.

14. The method of claim 1, wherein the rating information corresponds to ratings received from one or more other users for the previously selected items by the one or more other users.

15. A non-transitory computer-readable storage medium storing instructions, wherein execution of the instructions by the processing device causes the processing device to perform a method for recommending an item comprising:
executing code to determine statistical information in response to a recommendation request associated with a user, the statistical information including a mean vector and a covariance matrix, the mean vector and the covariance matrix being estimated based on rating information associated with previously selected items;
calculating a selection likelihood statistic, specific to the user, for a previously unselected item available for selection by the user, the selection likelihood statistic being calculated based on the estimated mean vector, the estimated covariance matrix, and rating information associated with the previously selected item; and
programmatically outputting a recommendation for the previously unselected item based on the selection likelihood statistic.

16. The medium of claim 15, wherein the method performed upon execution of the instructions further comprises calculating a ranking statistic for the previously unselected item based on the selection likelihood statistic.

17. The medium of claim 15, wherein recommending the previously unselected item comprises transmitting a response to the recommendation request, the response including a recommendation recommending the previously unselected item.

18. The medium of claim 15, wherein the selection likelihood statistic comprises a conditional mean vector associated with the user and a conditional covariance matrix associated with the user.

19. The medium of claim 18, wherein the method performed upon execution of the instructions further comprises calculating a ranking statistic for the previously unselected item based on the selection likelihood statistic, and
wherein the ranking statistic comprises one or more weights calculated as the product of the inverse of the conditional covariance matrix and the conditional mean vector.

20. A system for recommending an item comprising:
a non-transitory computer-readable medium storing instructions for execution of a recommendation process; and
a processing device in communication with the non-transitory computer-readable medium, the processing device being programmed to execute the instructions to:
determine statistical information in response to a recommendation request associated with a user, the statistical information including a mean vector and a covariance matrix, the mean vector and the covariance matrix being estimated based on rating information associated with previously selected items;
calculate a selection likelihood statistic, specific to the user, for a previously unselected item available for selection by the user, the selection likelihood statistic being calculated based on the estimated mean vector, the estimated covariance matrix, and rating information associated with the previously selected item; and
output a recommendation for the previously unselected item based on the selection likelihood statistic.

21. The system of claim 20, wherein the selection likelihood statistic comprises a conditional mean vector associated with the user and a conditional covariance matrix associated with the user.

22. The system of claim 20, wherein the processing device is programmed to calculate a ranking statistic for the previously unselected item based on the selection likelihood statistic, and
wherein the ranking statistic comprises one or more weights calculated as the product of the inverse of the conditional covariance matrix and the conditional mean vector.
